(19) United States
(12) Patent Application Publication
(10) Pub. No.: US 2024/0335961 A1
(43) Pub. Date: Oct. 10, 2024

(54) Cable Tie-Cutting Device

(71) Applicant: Colleen Pritchett, Seaside, CA (US)

(72) Inventor: Colleen Pritchett, Seaside, CA (US)

(21) Appl. No.: 18/623,633

(22) Filed: Apr. 1, 2024

Related U.S. Application Data
(60) Provisional application No. 63/494,058, filed on Apr. 4, 2023.

(51) Int. Cl. B26B 13/06

(52) U.S. Cl. CPC B26B 13/06

(57) ABSTRACT

A cable tie-cutting device is provided. The device is designed for safely cutting cable ties without causing injury or damage to a user and/or surrounding objects, items, and surfaces. The device comprises two arms, each with a handle. The other end of each arm features a blunt, rounded shape with a sharp interior cutting edge for slicing through cable ties from either side, designed to prevent accidental cuts or injuries during or post-use due to the shape of each end. A pivotal point, such as a rivet, connects the two arms, allowing for a cutting motion. Additionally, the device includes a fastener mechanism that can be attached to various objects or worn items, facilitating easy access and portability. This feature is achieved through the use of a secondary fastener, such as a split ring, connecting the fastener to at least one of the handles.

### CROSS-REFERENCE TO RELATED APPLICATION

The present application claims priority to, and the benefit of, U.S. Provisional Application No. 63/494,058, which was filed on Apr. 4, 2023, and is incorporated herein by reference in its entirety.

### FIELD OF THE INVENTION

The present invention relates generally to the field of cutting tools. More specifically, the present invention relates to a cable tie-cutting device designed for safely cutting cable ties and other objects, featuring two arms with a blunt, rounded shape to prevent accidental injuries. Accordingly, the present disclosure makes specific reference thereto. Nonetheless, it is to be appreciated that aspects of the present invention are also equally applicable to other like applications, devices, and methods of manufacture.

### BACKGROUND

Cable ties serve a multitude of purposes in both professional settings and day-to-day tasks due to their durability and ease of use. However, many cable ties are thick and robust and are designed to secure items tightly. This makes it difficult to cut through a cable tie. This difficulty is compounded by the fact that having the appropriate cutting tools readily available is not always guaranteed. In situations where urgency or necessity dictates the immediate removal or adjustment of these ties, individuals might resort to using whatever tools are at hand, such as scissors or the tip of a knife.

Further, attempting to wedge a pair of scissors or the tip of a knife between the tight confines of a cable tie and the secured object carries with it a significant risk of accidental damage. This risk is not limited to the surrounding objects or items that the cable tie is securing and also extends to the individual attempting the cut. The close proximity required to slice through the tie increases the likelihood of the tool slipping or applying too much force, potentially resulting in cuts or injuries to the hands or other parts of the body.

Moreover, the issue extends beyond just the removal of cable ties. There are numerous scenarios where a user might need to cut or remove an object without the risk of damaging nearby areas or items with the cutting tool. This is particularly true in sensitive environments where precision is paramount, and any collateral damage from a cutting tool could have significant repercussions.

Therefore, there exists a long-felt need in the art for an improved cutting device. There also exists a long-felt need in the art for a cable tie-cutting device. Further, there exists a long-felt need in the art for a cable tie-cutting device that can be used to cut a cable tie without damaging the item, surface, object, etc. that the cable tie is attached to during or after the cutting process. In addition, there exists a long-felt need in the art for a cable tie-cutting device that can be used to cut a cable tie without damaging or injuring a user during or after the cutting process. Further, there exists a long-felt need in the art for a cable tie-cutting device that provides the above functions wherein the device can remain easily accessible to a user.

The subject matter disclosed and claimed herein, in one embodiment thereof, comprises a cable tie-cutting device. The device is designed for safely cutting cable ties without causing injury or damage to a user and/or surrounding objects, items, and surfaces. The device comprises two arms, each with a handle. The other end of each arm features a blunt, rounded shape with a sharp interior cutting edge for slicing through cable ties from either side, designed to prevent accidental cuts or injuries during or post-use due to the shape of each end. A pivotal point, such as a rivet, connects the two arms, allowing for a cutting motion. Additionally, the device includes a fastener mechanism that can be attached to various objects or worn items, facilitating easy access and portability. This feature is achieved through the use of a secondary fastener, such as a split ring, connecting the fastener to at least one of the handles.

In this manner, the cable tie-cutting device of the present invention accomplishes all the forgoing objectives and provides an improved cutting device. More specifically, the device can be used to cut a cable tie without damaging the item, surface, object, etc. that the cable tie is attached to during or after the cutting process. In addition, the device can be used to cut a cable tie without damaging or injuring a user during or after the cutting process. Further, the device provides the above functions wherein the device can remain easily accessible to a user via the fastener.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cable tie-cutting device comprised of a scissor-like tool that can be used to cut cable ties or any other item, object, etc. without risky injury and/or damage from the ends of the device itself during cutting or immediately after a cut has been made.

The device is comprised of two arms. A first end of each arm is comprised of at least one handle. Each arm is also comprised of a second end that is preferably any shape that is rounded, blunt, etc. More specifically, the second end preferably has a smooth, rounded exterior edge and a sharp, bladed cutting edge. The cutting edge is used to cut a table tie from a first side of the cable tie. The blunt shape of the second end and the smooth rounded exterior edge ensures the second end does not inadvertently cut and/or injure a user using the device to cut a cable tie during or after the cable tie has been cut.

The device may also be comprised of at least one fastener that attaches to at least one handle via at least one secondary fastener such as but not limited to a split ring. The fastener allows the device to be attached to a belt loop, a pocket, a surface, a necklace, a bracelet, a lanyard, etc., and may be comprised of a fastener such as but not limited to a clip, a clasp, a magnet, a loop, a tie, etc.

The device is also comprised of a method of using the device. First, a device is provided comprised of a first arm comprised of a first end comprised of a handle and a second end comprised of a blunt shape with a rounded exterior edge and an interior cutting edge, and a second arm attached to the first arm via at least one pivot point, the second arm comprised of a first end comprised of a handle and a second end comprised of a blunt shape with a rounded exterior edge and an interior cutting edge. Then, the second end of the first arm can be positioned on a first side of a cable tie. Then, a second end of the second arm can be positioned on a second side of a cable tie. Then, the handles of both arms can be squeezed towards one another to cut the cable tie from both sides via the cutting edge of both arms in a manner wherein the second end cannot injure/cut a user during or after making the cut.

Accordingly, the cable tie-cutting device of the present invention is particularly advantageous as it provides an improved cutting device. More specifically, the device can be used to cut a cable tie without damaging the item, surface, object, etc. that the cable tie is attached to during or after the cutting process. In addition, the device can be used to cut a cable tie without damaging or injuring a user during or after the cutting process. Further, the device provides the above functions wherein the device can remain easily accessible to a user via the fastener. In this manner, the cable tie-cutting device overcomes the limitations of existing cutting tools known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top view of one potential embodiment of a cable tie-cutting device of the present invention in accordance with the disclosed architecture; and

FIG. 2 illustrates a flowchart of a method of using one potential embodiment of a cable tie-cutting device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved cutting device. There also exists a long-felt need in the art for a cable tie-cutting device. Further, there exists a long-felt need in the art for a cable tie-cutting device that can be used to cut a cable tie without damaging the item, surface, object, etc. that the cable tie is attached to during or after the cutting process. In addition, there exists a long-felt need in the art for a cable tie-cutting device that can be used to cut a cable tie without damaging or injuring a user during or after the cutting process. Further, there exists a long-felt need in the art for a cable tie-cutting device that provides the above functions wherein the device can remain easily accessible to a user.

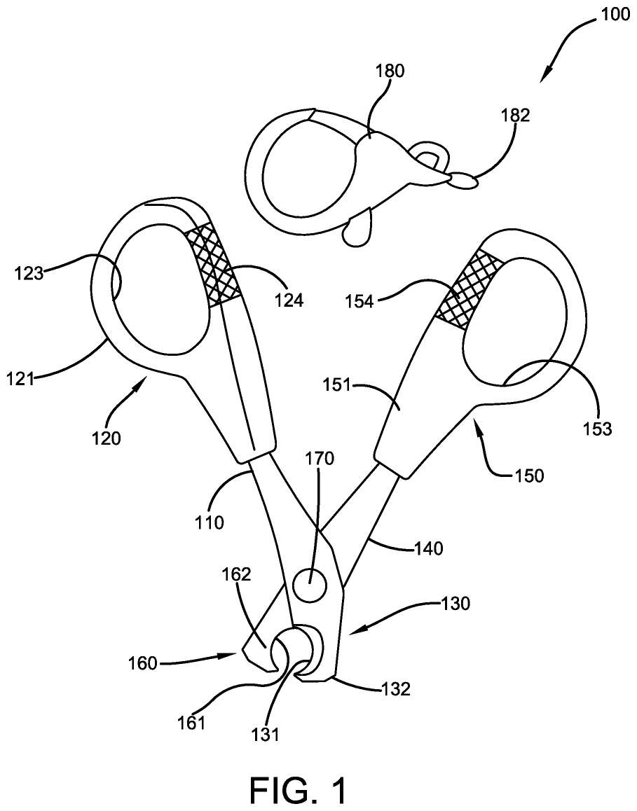

Referring initially to the drawings, FIG. 1 illustrates a top view of one potential embodiment of a cable tie-cutting device 100 of the present invention in accordance with the disclosed architecture. The device 100 is comprised of a scissor-like tool that can be used to cut cable ties or any other item, object, etc. without risky injury and/or damage from the ends of the device 100 itself during cutting or immediately after a cut has been made.

The device 100 is comprised of a first arm 110. A first end 120 of the first arm 110 is comprised of at least one handle 121. The handle 121 may be made from any material. The handle 121 may be any style, shape, and configuration of handle known in the art. In one embodiment, the handle 121 is comprised of a loop handle comprised of at least one opening 123 that a user can place their hand through/into while gripping the handle 121. The handle 121 may be comprised of at least one grip area 124. The grip area 124 may be comprised of a raised and/or recessed texture to improve grip. The grip area 124 may be made from the same material as the handle 121 or a differing material, such as but not limited to a non-slip rubber. The grip area 124 may be positioned anywhere on the handle 121.

The first arm 110 is also comprised of a second end 130. The second end 130 is preferably any shape that is rounded, blunt, etc. More specifically, the second end 130 preferably has a smooth, rounded exterior edge 132 and a sharp, bladed cutting edge 131 positioned on an interior edge of the second end 130. The cutting edge 131 is used to cut a table tie from a first side of the cable tie. The blunt shape of the second end 130 and the smooth rounded exterior edge 132 ensures the second end 130 does not inadvertently cut and/or injure a user using the device 100 to cut a cable tie during or after the cable tie has been cut.

The device 100 is comprised of a second arm 140 that attaches to the first arm 110 via at least one pivot point 170 such as but not limited to a rivet that allows the arms 110,140 to rotate around the point 170 to achieve a cutting action. A first end 150 of the second arm 140 is comprised of at least one handle 151. The handle 151 may be made from any material. The handle 151 may be any style, shape, and configuration of handle known in the art. In one embodiment, the handle 151 is comprised of a loop handle comprised of at least one opening 153 that a user can place their hand through/into while gripping the handle 151. The handle 151 may be comprised of at least one grip area 154. The grip area 154 may be comprised of a raised and/or recessed texture to improve grip. The grip area 154 may be made from the same material as the handle 151 or a differing material, such as but not limited to a non-slip rubber. The grip area 154 may be positioned anywhere on the handle 151.

The second arm 140 is also comprised of a second end 160. The second end 160 is preferably any shape that is rounded, blunt, etc. More specifically, the second end 160 preferably has a smooth, rounded exterior edge 162 and a sharp, bladed cutting edge 161 positioned on an interior edge of the second end 160. The cutting edge 161 is used to cut a table tie from a second side of the cable tie. The blunt shape of the second end 160 and the smooth rounded exterior edge 162 ensures the second end 160 does not inadvertently cut and/or injure a user using the device 100 to cut a cable tie during or after the cable tie has been cut.

The device 100 may also be comprised of at least one fastener 180. The fastener 180 attaches to at least one handle 121,151 via at least one secondary fastener 182 such as but not limited to a split ring. The fastener 180 allows the device 100 to be attached to a belt loop, a pocket, a surface, a necklace, a bracelet, a lanyard, etc., and may be comprised of a fastener such as but not limited to a clip, a clasp, a magnet, a loop, a tie, etc.

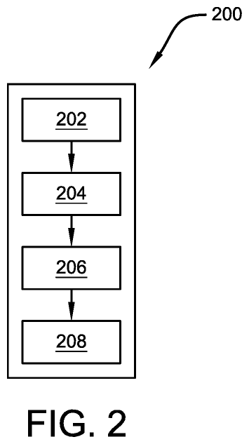

The device 100 is also comprised of a method 200 of using the device 100, as seen in FIG. 2. First, a device 100 is provided comprised of a first arm 110 comprised of a first end 120 comprised of a handle 121 and a second end 130 comprised of a blunt shape with a rounded exterior edge 132 and an interior cutting edge 131, and a second arm 140 attached to the first arm 110 via at least one pivot point 170, the second arm 140 comprised of a first end 150 comprised of a handle 151 and a second end 160 comprised of a blunt shape with a rounded exterior edge 162 and an interior cutting edge 162 [Step 202]. Then, the second end 130 of the first arm 110 can be positioned on a first side of a cable tie [Step 204]. Then, a second end 160 of the second arm 140 can be positioned on a second side of a cable tie [Step 206]. Then, the handles 121,151 of both arms 110,140 can be squeezed towards one another to cut the cable tie from both sides via the cutting edge 131,161 of both arms 110,140 in a manner wherein the second ends 130,160 cannot injure/cut a user during or after making the cut [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cable tie-cutting device” and “device” are interchangeable and refer to the cable tie-cutting device 100 of the present invention.

Notwithstanding the forgoing, the cable tie-cutting device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the cable tie-cutting device 100 as shown in the FIGS. are for illustrative purposes only, and that many other sizes and shapes of the cable tie-cutting device 100 are well within the scope of the present disclosure. Although the dimensions of the cable tie-cutting device 100 are important design parameters for user convenience, the cable tie-cutting device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cable tie-cutting device comprising:
a first arm comprised of a first end comprised of a first handle and a second end comprised of a first rounded exterior edge and a first cutting edge; and
a second arm attached to the first arm by a pivot point, the second arm comprised of a third end comprised of a second handle and a fourth end comprised of a second rounded exterior edge and a second cutting edge.

2. The cable tie-cutting device of claim 1, wherein the first handle is comprised of a first opening.

3. The cable tie-cutting device of claim 1, wherein the second handle is comprised of a second opening.

4. The cable tie-cutting device of claim 1, wherein the first handle is comprised of a first grip area.

5. The cable tie-cutting device of claim 1, wherein the second handle is comprised of a second grip area.

6. The cable tie-cutting device of claim 1, wherein the pivot point is comprised of a rivet.

7. A cable tie-cutting device comprising:
a first arm comprised of a first end comprised of a first handle and a second end comprised of a first rounded exterior edge and a first cutting edge;
a second arm attached to the first arm by a pivot point, the second arm comprised of a third end comprised of a second handle and a fourth end comprised of a second rounded exterior edge and a second cutting edge; and
a fastener comprised of a secondary fastener.

8. The cable tie-cutting device of claim 7, wherein the first handle is comprised of a first opening.

9. The cable tie-cutting device of claim 7, wherein the second handle is comprised of a second opening.

10. The cable tie-cutting device of claim 7, wherein the first handle is comprised of a first grip area.

11. The cable tie-cutting device of claim 7, wherein the second handle is comprised of a second grip area.

12. The cable tie-cutting device of claim 7, wherein the pivot point is comprised of a rivet.

13. The cable tie-cutting device of claim 7, wherein the first fastener is comprised of a clip, a clasp, a magnet, a loop, or a tie.

14. The cable tie-cutting device of claim 7, wherein the second fastener is comprised of a split ring.

15. A method of using a cable tie-cutting device, the method comprising the following steps:
providing a cable tie-cutting device comprised of a first arm comprised of a first end comprised of a first handle and a second end comprised of a blunt shape with a rounded exterior edge and a first interior cutting edge, and a second arm attached to the first arm via a pivot point, the second arm comprised of a third end comprised of a second handle and a fourth end comprised of a blunt shape with a rounded exterior edge and a second interior cutting edge;
positioning the second end of the first arm on a first side of a cable tie;
positioning a fourth end of the second arm on a second side of the cable tie; and
squeezing the first handle towards the second handle.

16. The method of using a cable tie-cutting device of claim 15, wherein the first handle is comprised of a first opening.

17. The method of using a cable tie-cutting device of claim 15, wherein the second handle is comprised of a second opening.

18. The method of using a cable tie-cutting device of claim 15, wherein the first handle is comprised of a first grip area.

19. The method of using a cable tie-cutting device of claim 15, wherein the second handle is comprised of a second grip area.

20. The method of using a cable tie-cutting device of claim 15, wherein the pivot point is comprised of a rivet.
